(19) United States
(12) Patent Application Publication
(10) Pub. No.: US 2021/0180474 A1
(43) Pub. Date: Jun. 17, 2021

(54) Turbostirling Engine

(71) Applicant: William H.T. La, Stockton, CA (US)

(72) Inventor: William H.T. La, Stockton, CA (US)

(21) Appl. No.: 16/718,028

(22) Filed: Dec. 17, 2019

(51) Int. Cl. F01K 21/00; F01K 13/00

(52) U.S. Cl. CPC F01K 21/00; F01K 13/00

(57) ABSTRACT

A Stirling cycle heat engine 10 includes one moving part, rotor 24 that combines the traditional functions of piston, displacer, and flywheel. There is no reciprocating motion and no travel of the center of gravity. It can be built as a hermetically closed unit with few parts.

### CROSS-REFERENCE TO RELATED APPLICATIONS

This application claims the benefit of provisional patent application Ser. No. 62/917,607, filed 2018 Dec. 17 by the present inventor.

### BACKGROUND

A heat engine is a thermomechanical device that converts part of the heat flow from a high-temperature source to a low-temperature sink into mechanical work. Heat engines currently in common use, such as automobile power plants, are of the internal combustion type. These require a specialized liquid fuel with a narrow range of properties. By contrast, an external-fuel device such as the Stirling engine can use a variety of heat sources, including waste process heat and solar thermal energy. However, being poorly responsive to varying output requirement, the Stirling engine is not suited for directly powering a car. Instead, it is well-adapted for applications where a steadier power delivery is expected, such as for electricity generation from external fuel combustion, for solar thermal power collection, and for waste heat recovery.

### RELATED ART

A conventional Stirling engine includes at least two reciprocating parts, either two pistons, or a piston and a displacer, mechanically connected to a flywheel through a system of crankshaft and pushrods. The piston is exposed on one side to the ambient atmosphere, and the displacer's pushrod also slides through an opening in the housing. While it is thermodynamically advantageous to use a gaseous working fluid other than air and under high pressure, this arrangement suffers from the difficulty to confine the gas and compensate for the pressure differential.

U.S. Pat. No. 4,036,018 to Beale (1977), describes a sealed system that circumvents the problem of working fluid leakage. The reciprocating motions of piston and displacer require special attention to issues of sliding suspension and electronic feedback control of the oscillations. These are addressed in later patents by the same inventor. This design has been adapted for use in space vehicles, and in concentrating thermal solar generators with limited success.

Rotary displacers combined with a linear piston are shown in U.S. Pat. No. 8,485,873 B2 to Foster (2013). Different methods have been proposed for using Wankel-type rotary pistons, such as shown in U.S. Pat. No. 3,958,422 to Kelly (1976), U.S. Pat. No. 6,109,040 to Ellison, Jr. et al. (2000), and U.S. Pat. No. 9,086,013 B2 to Franklin (2015). These designs exhibit a substantial degree of complexity, and the eccentric geometry of the rotary elements only offers a partial improvement on the vibration inherent in reciprocating parts and travelling centers of gravity.

### Advantages

The Stirling cycle heat engine of the present invention is of simple construction and can be built requiring only one moving mechanical part. The rotor performs the functions of the piston, displacer, and flywheel individually instantiated in a conventional Stirling engine. There are no articulations or linkages.

This motor generates minimal vibration and noise. The only mechanical action involved is the rotation of a symmetrical, fixed-geometry rotor around a fixed axis. There is no reciprocating travel of a physical part, and no significant periodic displacement of the center of gravity.

The working fluid in this assembly has no leakage path to the environment through a linear sliding joint since no reciprocating piston is used, eliminating a problem that challenges other Stirling engine designs.

This device can be efficiently and compactly implemented in various form factors, from a stackable block externally heated through the combustion of various fuels or concentrated solar irradiation, to a thin plate suitable for operation under solar thermal power, either through direct insolation or as a waste-heat collector underlining a photovoltaic panel, enabling cartop application.

This thermomechanical converter can be assembled from as few as three snap-together integral components, suitable for use as an inexpensive scientific toy.

### DRAWING—FIGURES

FIG. 1—Perspective exploded view of engine

FIG. 2—Detailed perspective view of rotor

FIG. 3—Perspective view of working fluid chamber

FIG. 4—Perspective view of assembled engine

FIG. 5—Perspective exploded view of gasketed engine

FIG. 6—Perspective view of assembled gasketed engine

FIG. 7—Cross-sectional view of engine with rotor in non-stroke position

FIG. 8—Cross-sectional view of engine with rotor entering stroke position

FIG. 9—Cross-sectional view of engine with rotor in stroke position

FIG. 10—Cross-sectional view of engine with rotor leaving stroke position

FIG. 11—Cross-sectional view of engine with offset stroke area

FIG. 12—Cross-sectional view of engine with shaped stroke area and rotor

FIG. 13—Cross-sectional view of engine with rotor conduit

FIG. 14—Cross-sectional view of engine with double rotor conduits

FIG. 15—Cross-sectional view of eolipile-like engine

### DRAWINGS—REFERENCE NUMERALS

10—Turbostirling engine
11a, 11b—Engine housing endplates
12—Engine housing body or engine block
12a, 12b—Engine housing halves
14—Hot side of housing at heat source
16—Cold side of housing at heat sink
18—Working fluid chamber
20—Working fluid
22—Rotor
23a, 23b—Rotor vanes
24—Rotor shaft
25a, 25b—Shaft bearing holes
26, 26b—Chamber passage, stroke area
27a, 27b—Engine housing gasket halves
28, 28b—Fluid flux or flow
30—Chamber passage upstream section
32—Chamber passage downstream section
34—Rotor tip concavity
36—Rotor central partition
38—Rotor elbow
40—Rotor proximal opening
42, 42b—Rotor peripheral, or distal, opening
44, 44b—Rotor shield

### DESCRIPTION

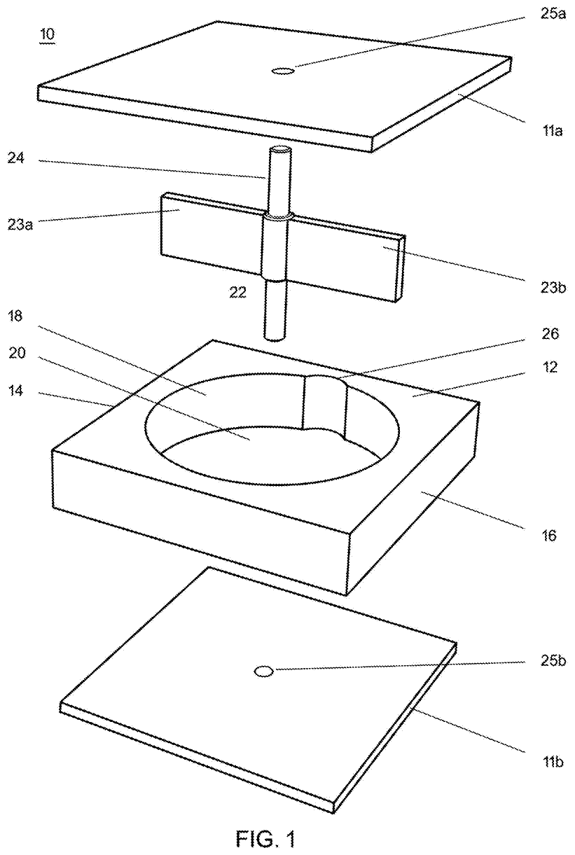

FIG. 1 shows the basic embodiment of this turbine-action Stirling cycle heat engine. Engine 10 comprises two endplates 11a and 11b sandwiching a housing 12 including a hot side 14, a cold side 16, and a cylindrical chamber 18 containing a working fluid 20 and a rotor 22 including two vanes 23a and 23b and a shaft 24 rotatably mounted in the housing through bearing holes 25a and 25b in plates 11a and 11b. Chamber 18 includes an appended cavity, or recessed wall feature, or passage 26 serving as a stroke area for rotary propulsion of rotor 22 by allowing periodic flux of fluid 20.

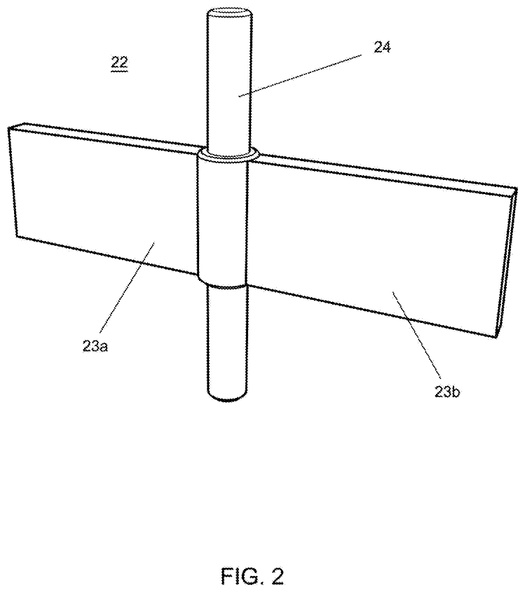

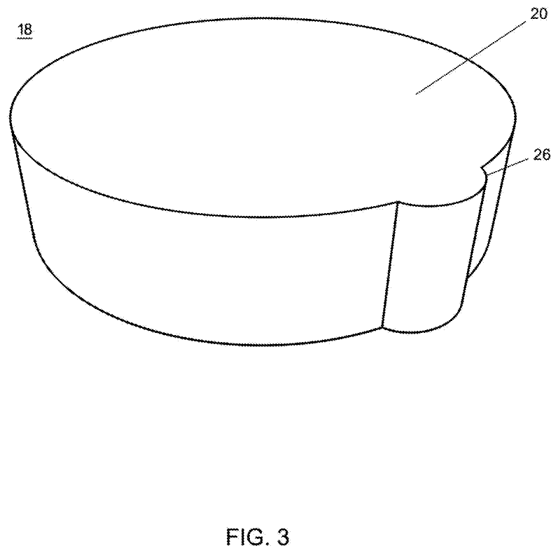

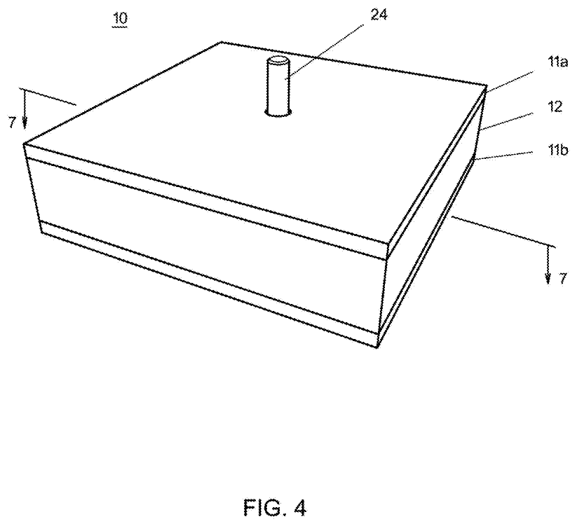

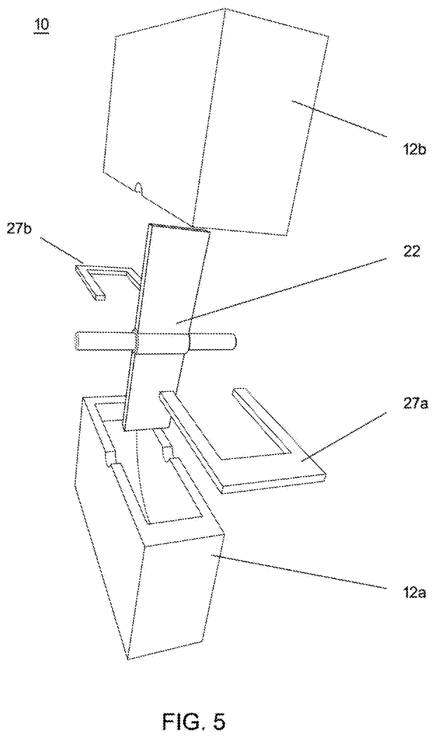

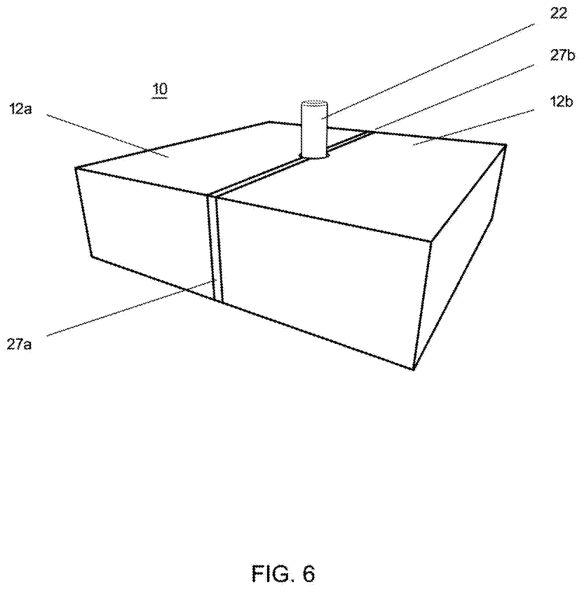

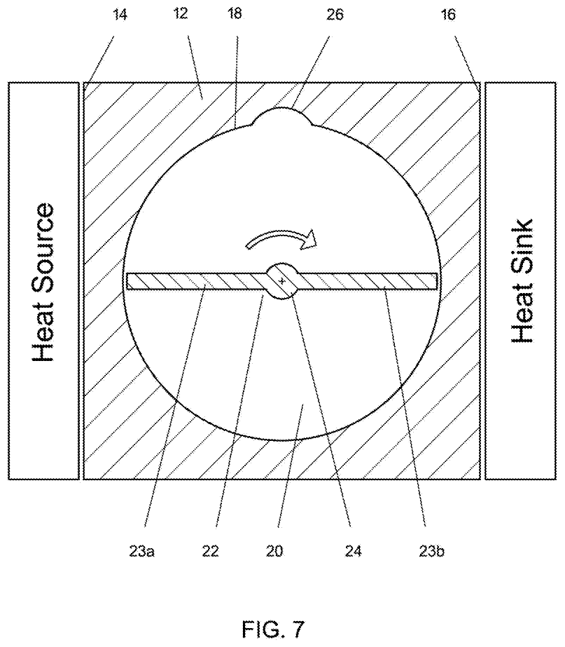

FIG. 2 shows a detailed view of rotor 22 with vanes 23a and 23b, and shaft 24. The vanes divide chamber 18 into two hemichambers that are isolated from each other during most of the rotation period of the rotor. FIG. 3 shows a detailed view of chamber 18 containing fluid 20. Wall recess 26 forms a bulge in the cylindrical fluid volume. Chamber 18 is topologically isomorphic with a sphere rather than a donut, which is a unique feature of this engine compared to other Stirling engines with a rotary piston/displacer. FIG. 4 shows engine 10 in its assembled configuration, with plates 11a and 11b cooperating with engine housing 12 to form an engine block enclosing fluid 20 and rotor 22, with shaft 24 protruding from the assembly. The midsectional cross-section view of engine 10 will later be shown in FIG. 7. The assembly may be held together with bolts or other fastening implements, and bearings may be used to minimize rotational friction, as is known in the art. FIG. 5 shows an alternate construction of engine 10 in which housing 12 comes in two halves 12a and 12b separated by gasket halves 27a and 27b, enclosing rotor 22 and the working fluid in an arrangement providing minimal heat loss through body conduction. FIG. 6 shows the assembled configuration of this alternate embodiment.

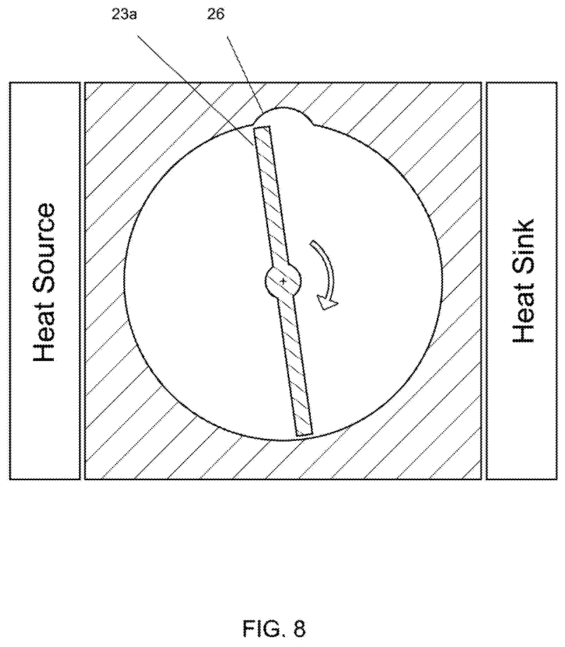

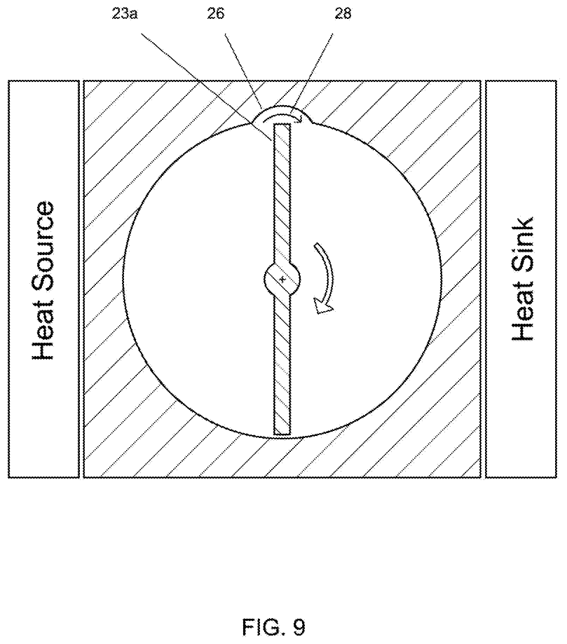

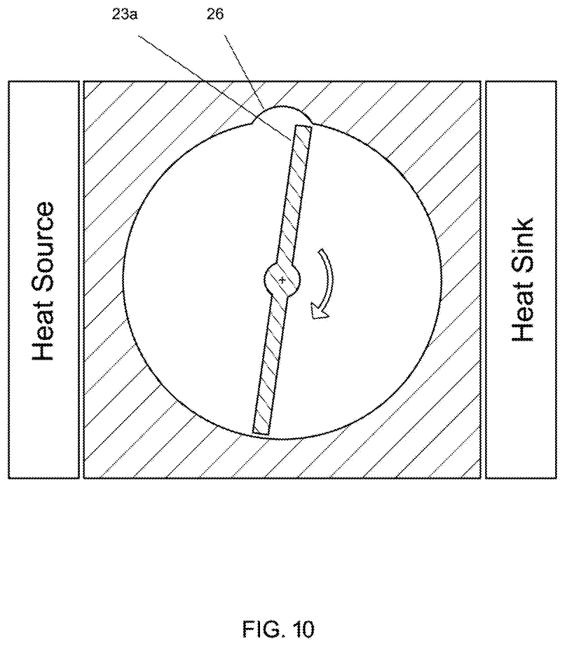

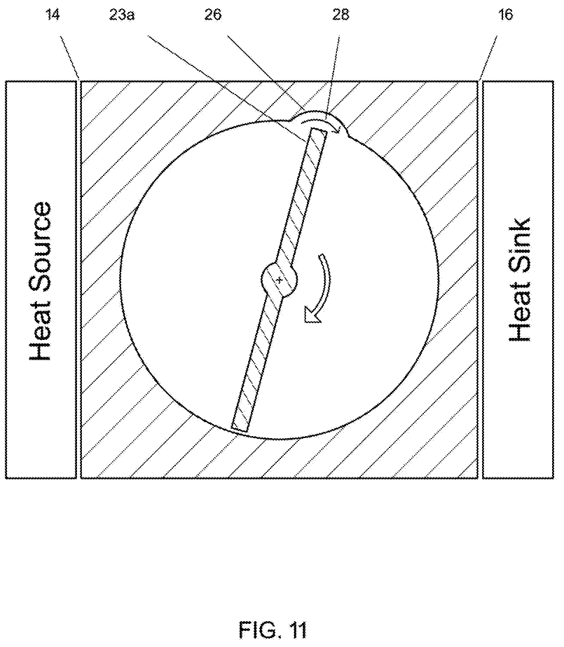

FIG. 7 shows a horizontal-midplane cross-sectional view of engine 10 with rotor vanes 23a and 23b far away from stroke area 26. FIG. 8 shows a similar view with vane 23a starting to engage area 26 and initiating a fluid flow between the hemichambers. FIG. 9 shows rotor vane 23a in full engagement with stroke area 26, allowing a fluid flow 28 in passageway 26 from the currently hot hemichamber into the currently cold hemichamber, providing an impulse of propulsive stroke on the rotor. FIG. 10 shows the position of vane 23a at the end of the motive stroke, pinching off the fluid flux. The mechanical impulse lasts only for a small fraction of the rotation cycle, when vane 23a or 23b transit, the stroke zone. FIG. 11 shows an alternate configuration where stroke zone 26 is slightly offset away from hot wall 14 toward cold wall 16 to compensate for heat transfer delays between the chamber walls and the working fluid.

### Operation:

In normal operation as shown in FIG. 1, hot side 14 is brought in thermal contact with a relatively higher-temperature heat source, and cold side 16 contacts a lower-temperature heat sink. A temperature gradient is thus set up across engine housing 12. Rotor 22 fits with close tolerance in cylindrical chamber 18 and divides its space into two hemichambers filled with working fluid 20, which can be air or some other gas. As the rotor spins at a steady speed, the fluid contained in each hemichamber is periodically heated and cooled. The temperature vs. time plot exhibits a roughly sinusoidal shape, with a phase difference of 180 degrees between the curves corresponding to the two hemichambers. As any one of the two rotor tips approaches chamber passage 26, the fluid on the side of its trailing edge is at a higher temperature and pressure than the fluid on the side of its leading edge thanks to ongoing heat exchange with the inner walls of the housing, on both the hot and cold sides. As the rotor tip engages chamber passage 26, a rheological communication is established between the two hemichambers, and the pressure differential between them induces transient flow 28 of fluid across the passage, imparting an impulse on the rotor and sustaining its continued motion. The total volume of working fluid in the engine remains constant, the pulsatile flow decompressing the fluid in the hotter hemichamber and correspondingly compressing the fluid in the colder hemichamber. As the rotor spins, the same, relatively small, volume of gas pulse is exchanged, back and forth between the two hemichambers on its two sides. A portion of the heat transfer from the source to the sink is accomplished through the cyclical change in the fluid's state in each hemichamber, and work can be extracted from the rotor as a result.

This device can be conceptualized as a closed-turbine, or sealed-turbine, heat engine, where the fluid on each side undergoes an approximate cycle of isochoric heat addition, adiabatic expansion, isochoric heat extraction, and adiabatic compression. While the Otto cycle of an internal combustion engine shares the same thermodynamic constituents, the present device is fundamentally different in that it involves no internal combustion, and no intake and exhaust of working fluid. In that respect, it shares more kinship with a Stirling engine. Moreover, even though the Stirling cycle is idealized as a combination of isochoric and isothermal processes, the PV diagram of a physical Stirling engine is only a coarse approximation of the ideal curve and depends on its construction and type, either alpha, beta, or gamma. For these reasons, the present device may be evocatively referred to as a turbostirling engine.

For best performance, the rotor is preferably made of an insulating material and the housing preferably comprises two heat-conductive halves, respectively for the hot and cold sides, joined through an insulating gasket. The working fluid is preferably hermetically sealed inside the chamber at an elevated pressure. Electrical power may be tapped through an internal generator coupled to the rotor, in which case the unit can be hermetically sealed, as in designs advanced by Beale. If mechanical power is to be extracted directly through a shaft extending outside the housing, gas-tight, impermeable bearings would preferably be used.

### Alternative Embodiments

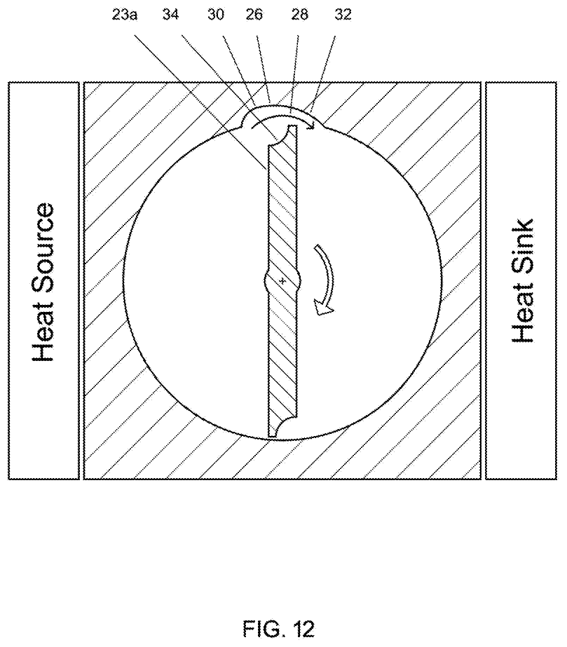

FIG. 12 shows an improved design of the chamber passage and the rotor tip to maximize the impact of the fluid flow on rotor motion. The chamber's appendiceal cavity 26 which accommodates flow 28 is configured asymmetrically, with an upstream concavity 30 having a smaller radius of curvature and a sharper angle of intersection with the chamber's cylindrical wall, and a downstream concavity 32 having a larger radius of curvature and a shallower angle of intersection with the chamber's cylindrical wall. The rotor's tip is configured with a concavity 34 on the trailing side. These features allow stream 28 to exert a stronger motive force on the rotor tip and a correspondingly stronger counterforce on the housing. Work is thus more efficiently transmitted to the mechanical parts from the motion of the working fluid. Nevertheless, in the cases of both this geometry and the basic scheme shown in FIG. 1, on account of the escape of fluid from the hot side to the cold side, an area of lower pressure develops in the hot hemichamber just upstream of flow 28 relative to the average pressure in this hemichamber. Similarly, an area of higher pressure develops in the cold hemichamber just downstream of flow 28 relative to the average pressure in this hemichamber. These localized zones of trailing-edge depressurization and leading-edge pressurization tend to counteract the forward-propelling force of the stream on the rotor, thereby impeding its rotation.

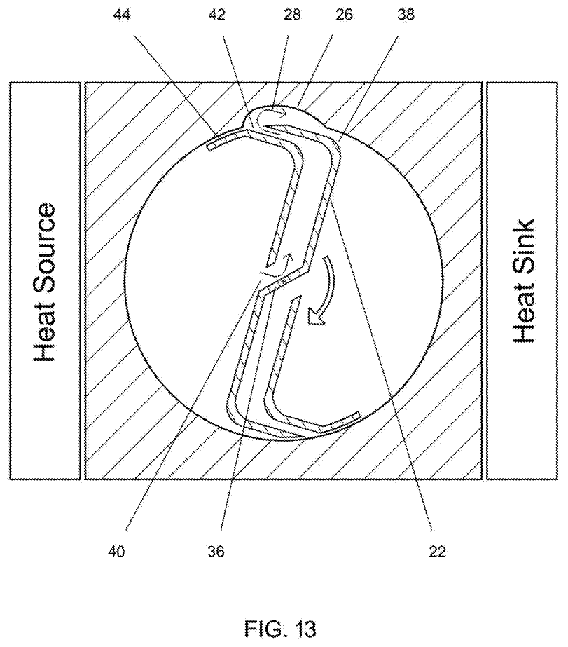

FIG. 13 shows a design that helps alleviate the back-pressure problem. Rotor 22 is a hollow structure with an internal conduit, symmetrically divided into two segments by central partition 36, each segment including an elbow 38, a centrally positioned proximal opening 40, a peripherally positioned distal opening 42, and a shield 44. When the rotor is engaged with the chamber passage, fluid flows through central opening 40 into the internal conduit and out through peripheral opening 42. Elbow 38 directs the exiting flow at a near-tangential angle, maximizing the impulse delivered to the rotor. Shield 44 prevents backflow into the hot hemichamber. Depressurization on the hot side now occurs centrally, without adverse effect on the rotor's motion.

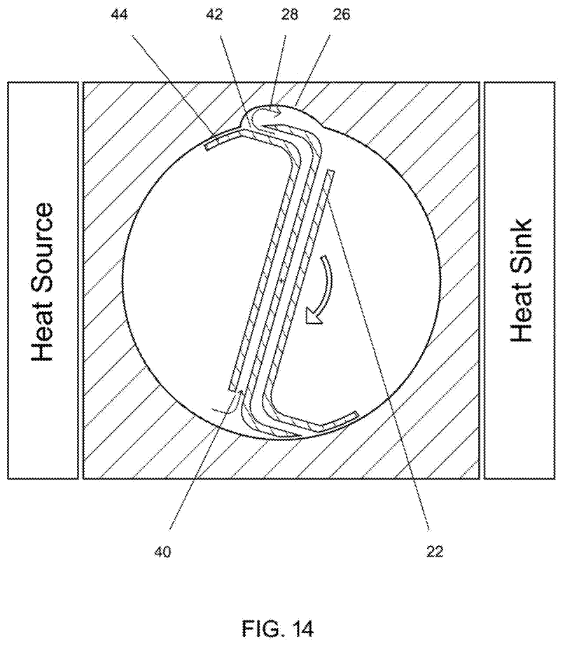

FIG. 14 shows a further improvement in which rotor 22 comprises two symmetrical parallel conduits, the proximal opening 40 of each being positioned near the distal opening 42 of the other. In this arrangement, the depressurization in the hot hemichamber becomes a net contributor to the rotor's motion.

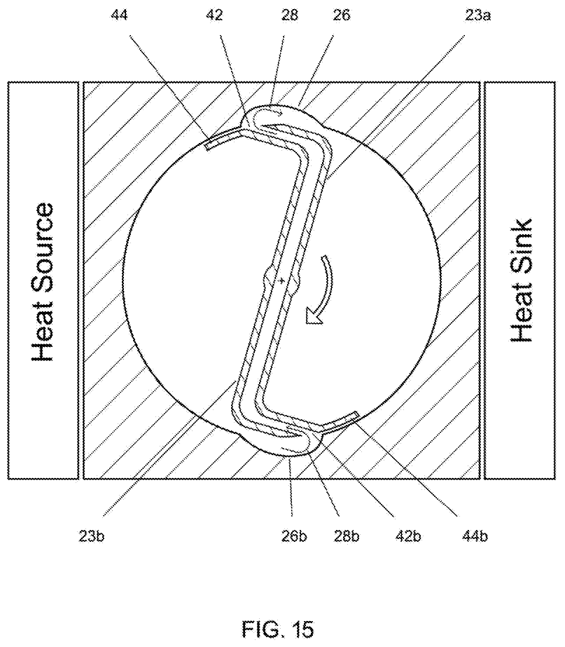

FIG. 15 shows a further improvement in which rotor 22 has an internal conduit connecting peripheral openings 42. The chamber has two symmetrically disposed passages at diametrically opposite locations, 26 and 26b, supporting an additional motive flow 28b at vane 23b with opening 42b and shield 44b. The working fluid flows inside the rotor from the hot to the cold hemichambers, symmetrically imparting a rotary impulse at both ends, with motive torque fulcrumed at the axis. This design provides balanced, efficient work delivery. The rotor spins in the same direction if the hot and cold sides are reversed, simplifying the starting requirement. This geometry echoes the configuration of the steam engine invented by Hero of Alexandria two millennia ago, and this device might be called the Stirling eolipile.

### CONCLUSIONS, RAMIFICATIONS, AND SCOPE

The embodiments provide a very simple device which converts a flow of heat into mechanical energy. Although the description above contains many specificities, these should not be construed as limiting the scope of the embodiments but as merely providing illustrations of some of several embodiments. For example, the chamber may be spherical and the rotor may be discoid. Thus, the scope of the embodiments should be determined by the appended claims and their legal equivalents, rather than by the examples given.

I claim:

1. A Stirling cycle heat engine including:
A working fluid;
A housing enclosing a chamber containing said working fluid, said housing defining a hot side in thermal communication with a heat source, and a cold side in thermal communication with a heat sink;
A rotor rotatably mounted within said housing and dividing said chamber into two isolated hemichambers, said rotor causing the fluid content of each said hemichamber to alternatively come in thermal communication with said hot side and said cold side;
Said chamber including an appended cavity allowing periodic fluid exchange between said hemichambers, the topography of said chamber being isomorphic with that of a sphere.

2. The device of claim 1 wherein the rotor includes an internal conduit accommodating said fluid exchange.

3. The device of claim 2 including two said appended cavities disposed in a diametrically opposed arrangement.
